(19) United States
(12) Patent Application Publication
(10) Pub. No.: US 2009/0016442 A1
(43) Pub. Date: Jan. 15, 2009

(54) Deblocking digital images

(75) Inventors: Sumankar Shankar, (US); Prasanna Ganesan, Menlo Park, CA (US)

Correspondence Address: SHEMWELL MAHAMEDI LLP, 4880 STEVENS CREEK BOULEVARD, SUITE 201, SAN JOSE, CA, 95129-1034, US

(73) Assignee: VVOND, INC.

(21) Appl. No.: 11/331,112

(22) Filed: Jan. 10, 2006

Related U.S. Application Data
(63) Continuation-in-part of application No. 11/244,885, filed on Oct. 6, 2005.

(51) Int. Cl. H04N 7/26

(52) U.S. Cl. 375/240.24; 382/232; 375/E07.075

(57) ABSTRACT

Techniques for deblocking digital images or frames are disclosed. According to one aspect of the present invention, a blurring process is configured to modify pixels on the blocking boundaries based on surrounding pixels in a region that is adaptively calculated. The deblocking process is particularly useful in compression standards that operate on variable blocks. The deblocking process can be used as postprocessing or implemented as an in-line deblocker.

### CROSS-REFERENCE TO RELATED APPLICATION

This is a continuation-in-part of co-pending U.S. application Ser. No. 11/244,885, entitled “Minimizing blocking artifacts in videos” and filed Oct. 6, 2005, and by at least one of the co-inventors hereof.

### BACKGROUND

1. Technical Field

The present invention relates generally to image processing, and more particularly to techniques for minimizing blocking artifacts in videos.

2. Description of the Related Art

Compression is a reversible conversion of data to a format that requires fewer bits, usually so performed that the data can be stored or transmitted more efficiently. In the area of video applications, compression or coding is performed when an input video stream is analyzed and information that is indiscernible to the viewer is discarded. Each event is then assigned a code—commonly occurring events are assigned few bits and rare events have more bits. The common techniques for video compression (e.g., MPEG-1, MPEG-2) divide images in small square blocks for processing. However, real objects in a scene are rarely a collection of square regions. Such block-based coding technique is used in many video compression standards, such as H.261, H.263, H.264, MPEG-1, MPEG-2, and MPEG4. When the compression ratio is increased, the compression process can create visual artifacts in the decoded images when displayed, referred to as blocking artifacts. The blocking artifacts occur along the block boundaries in an image and are caused by the coarse quantization of transform coefficients.

Image filtering techniques can be used to reduce the blocking artifacts in reconstructed images. The reconstructed images are the images produced after being inverse transformed or decoded. The rule of thumb in these techniques is that image edges should be smoothed while the rest of the image is preserved. Low pass filters are carefully chosen based on the characteristic of a particular pixel or set of pixels surrounding the image edges. In particular, non-correlated image pixels that extend across block boundaries in images are specifically filtered to reduce the blocking artifacts. However, such ideal low pass filtering is difficult to design, the commonly used low pass filtering can introduce blurring artifacts into the image. If there are little or no blocking artifacts between adjacent blocks, the low pass filtering may needlessly incorporate blurring into the image while at the same time wasting processing resources.

Various techniques have been proposed to remove the artifacts while preserving the video quality. One of the techniques is to determine the differences in least significant bits (LSB). For example, two adjacent pixels A and B along an image boundary have values 100 and 101 respectively, on a scale of 0 to 255 (8-bit precision). To simply remove the image boundary, it is ideal to replace both pixels with an average value 100.5. But given an 8-bit precision representation for the pixel values, the value 100.5 needs to be rounded up or down. In a standard blurring process, 100.5 may be rounded down to 100 for pixel A (since it was originally closer to 100) and rounded up to 101 for pixel B (since it was originally closer to 101). The consequence is that the values of the two adjacent pixels A and B do not change by the blurring method, and the image boundary is not eliminated.

In certain encoding techniques, the block sizes vary depending on the content in a block. Smooth areas sometimes have large blocks. When blurred, the rectangular areas may be still visible. For example, FIG. 1 shows a gray image in which the pixel values are gradually increasing from the top left corner to the bottom right corner. However, human eyes can perceive a lot of bands in the digital image. These bands may be what are referred to as Mach bands that exaggerate the change in intensity at any boundary where there is a discontinuity in magnitude or slope of intensity. Such bands are not desirable in smooth areas in a scene.

Thus techniques are needed to minimize these visual artifacts to preserve or enhance video quality.

### SUMMARY

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

Broadly speaking, the present invention is related to techniques for minimizing blocking artifacts in video images or frames. In general, these blocking artifacts are the result of block-based compression standards, such as MPEG-1, MPEG-2, MPEG-4, H.261, H.263, and H.264. According to one aspect of the present invention, a blurring process is configured to replace pixels on the blocking boundaries with a computed value within respective regions, each of the regions is adaptively determined with respect to a pixel being modified and surrounding pixels thereof. In a certain perspective, a blocking boundary is thus diffused without introducing blurring to pixels other than the blocking artifacts. According to another aspect to the present invention, pixels in an image or frame are sequentially processed by a process that is configured to smooth only those pixels that may cause subjective perception of the blocking artifacts.

Depending on implementation, the process contemplated in the present invention may be implemented as post-processing after compressed data is decoded or decompressed, or as an add-on in an in-loop deblocker. The process may be implemented in software, hardware, or a combination of both as a method, an apparatus or a system. According to one embodiment, the present invention is a method for minimizing blocking artifacts in an image, the method comprises determining a pixel to be processed, defining a region adaptively with respect to the pixel, and the region determined in accordance with a smaller one of two values: a length of identical pixels on a left side and a length on a right side of the pixel determined above; and truncating a floating point number after the floating point number is added a random floating point number between 0 and 1, wherein the floating point number is a result of a convolution computation on surrounding pixels and the determined pixel.

According to one embodiment, the present invention is an apparatus for minimizing blocking artifacts in an image, the apparatus comprises: memory for storing code as a deblocking module, and a processor, coupled to the memory, executing the deblocking module to cause the apparatus to perform operations of: defining a region adaptively with respect to the pixel, the region determined in accordance with a smaller one of two values: a length of identical pixels on a left side and a length on a right side of the pixel determined above; and truncating a number after the number is added a random floating point number between 0 and 1 or increased by a predefined number of bits, wherein the number is a result of a convolution computation on surrounding pixels and the determined pixel.

One of the objects of the present inventions is to provide techniques for minimizing blocking artifacts in video images or frames.

Other objects, features, advantages, benefits of the invention will become more apparent from the following detailed description of a preferred embodiment, which proceeds with reference to the accompanying drawings.

### BRIEF DESCRIPTION OF THE DRAWINGS

The invention will be readily understood by the following detailed description in conjunction with the accompanying drawings, wherein like reference numerals designate like structural elements, and in which:

FIG. 1 shows a gray image in which the pixel values are gradually increasing from top left corner to right bottom corner;

FIG. 2 shows an exemplary configuration system in which the present invention may be practiced;

FIG. 3A shows that compressed data received in whole or as streaming is being post-processed to remove the blocking artifacts in one embodiment; and

FIG. 3B shows that compressed data received in whole or as streaming is being post-processed to remove the blocking artifacts in another embodiment.

### DETAILED DESCRIPTION OF THE INVENTION

The invention is related to various techniques for the present invention is related to techniques for minimizing blocking artifacts in video images or frames. In general, these blocking artifacts are the result of block-based compression standards, such as MPEG-1, MPEG-2, MPEG-4, H.261, H.263, and H.264. According to one aspect of the present invention, a blurring process is configured to replace pixels on the blocking boundaries with computed pixels within respective regions, each of the regions is adaptively determined with respect to a pixel being replaced. According to another aspect to the present invention, pixels in an image or frame are sequentially processed by a process that is configured to smooth only those pixels that may cause subjective perception of the blocking artifacts.

In the following description, numerous specific details are set forth to provide a thorough understanding of the present invention. The present invention may be practiced without these specific details. The description and representation herein are the means used by those experienced or skilled in the art to effectively convey the substance of their work to others skilled in the art. In other instances, well-known methods, procedures, components, and circuitry have not been described in detail since they are already well understood and to avoid unnecessarily obscuring aspects of the present invention.

Reference herein to “one embodiment” or “an embodiment” means that a particular feature, structure, or characteristic described in connection with the embodiment can be included in at least one implementation of the invention. The appearances of the phrase “in one embodiment” in various places in the specification are not necessarily all referring to the same embodiment, nor are separate or alternative embodiments mutually exclusive of other embodiments. Further, the order of blocks in process, flowcharts or functional diagrams representing one or more embodiments, if any, do not inherently indicate any particular order nor imply limitations in the invention.

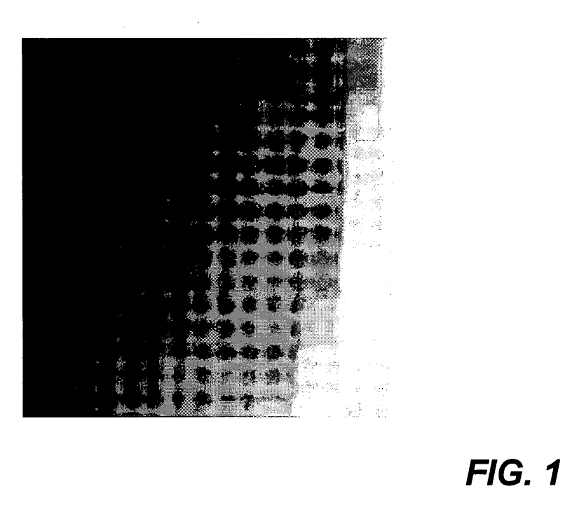

Embodiments of the invention are discussed herein with reference to FIGS. 1-3B. However, those skilled in the art will readily appreciate that the detailed description given herein with respect to these figures is for explanatory purposes as the invention extends beyond these limited embodiments

“Deblocking” images, as commonly used, is to remove blocking artifacts in the images. These blocking artifacts may be caused by a digital image process, such as scaling or decompression. A conventional deblocking method includes the following two steps.

Step 1: identifying pixel elements that require processing. The purpose is to detect or identify edges in an image by, for example, means of a threshold function. If color levels of adjacent pixels differ by a certain amount that is greater than a minimum threshold but smaller that a maximum threshold, a pixel being identified is considered an edge. The adjacent pixels may be chosen differently depending on an exact implementation.

Step 2: applying a blurring process to the pixels that have been identified. One exemplary blurring operation is a convolution operation that replaces a pixel value with a weighted average of surrounding pixels. The weights are determined by a spatial distance to the pixel being replaced. Depending on an exact implementation and application, the blurring process may be implemented differently.

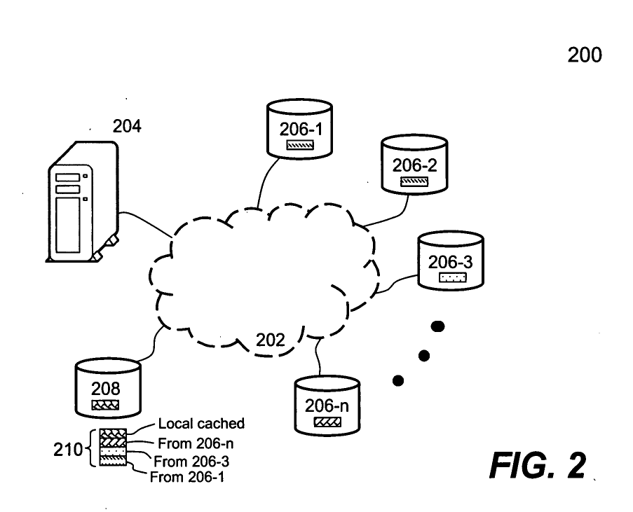

FIG. 2 shows an exemplary configuration system in which the present invention may be practiced. Coupled to the network 202, there are a server 204 and a plurality of local machines or boxes 206-1, 206-2, 206-3, . . . 206-n and 208. Each of the boxes 206-1, 206-2, 206-3, . . . 206-n and 208 includes or is connected to a display screen (not shown). In one embodiment, each of the boxes 206-1, 206-2, 206-3, . . . 206-n and 208 may correspond to a computing device, a set-top box, or a television. Each of the boxes 206-1, 206-2, 206-3, . . . 206-n and 208 may access compressed data representing one or more movies that may be locally or remotely provided.

According to one embodiment, any of the boxes 206-1, 206-2, 206-3, . . . 206-n and 208 may receive compressed data from the server 204 that centrally stores all video data and delivers required video data pertaining to an ordered title upon receiving a request. According to another embodiment, the server 204 is configured to identify one or more other boxes to supply pieces of compressed data to a box requesting the data. In other words, all video data is distributed among all boxes in service and the server 204 is not required to deliver all the data in response to a request, and instead is configured to provide source information as to where and how to retrieve some or all of the data from other boxes. As shown in FIG. 2B, a set of compressed video 210 for a movie includes four segments, one being locally available, and the other three segments are respectively fetched from the boxes 206-1, 206-3 and 206-n.

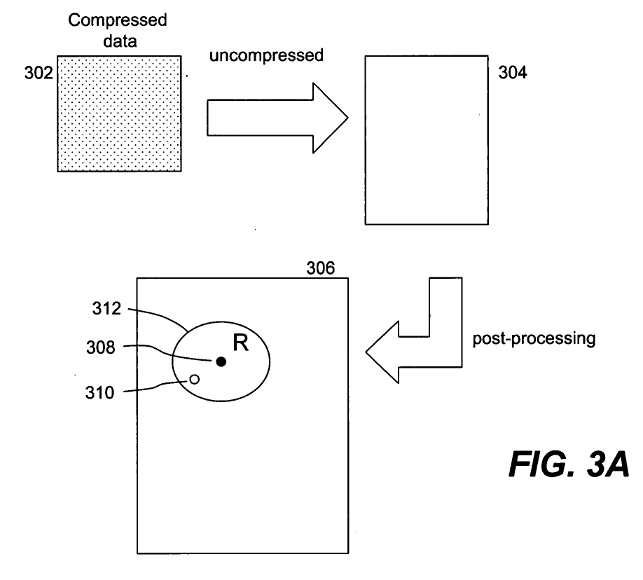

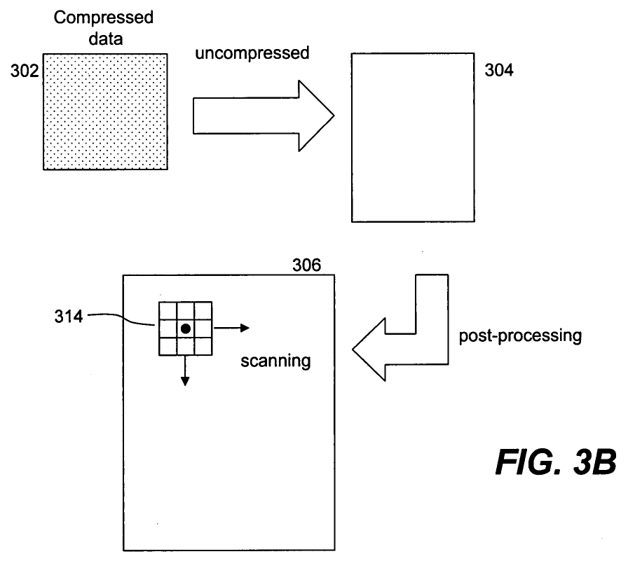

Referring now to FIG. 3A, it is assumed that compressed data 302 is received in whole or as streaming. After a reversal (decompression) process, data 304 is decoded or decompressed. It is understood that the data 304 is not exactly the replica of the original data represented by the compressed data 302. Therefore, the data 304 is sometimes referred to as lossy or intermediate data that includes artifacts and needs preferably post-processing before displayed on a screen.

It should be noted herein that a pixel, unless specifically stated, means either a scalar pixel or a vector pixel. Each pixel C(i, j) in a color image or frame is a vector pixel that may be expressed as follows:

$$C ( i , j ) = [ \begin{matrix}A ( i , j ) \\ B ( i , j ) \\ C ( i , j )\end{matrix} ]$$

where (i, j) are coordinates of a color image pixel and C refers to the color image and A, B and C are the respective three component intensity images representing the color image C. In the RGB representation, the three components become R(i, j), G(i, j) and B(i, j), wherein R, G, and B represent red, green, and blue component, respectively. In the YUV representation, the three components become Y(i, j), U(i, j) and V(i, j), wherein Y, U, and V represent luminance, and two chrominance. In any case, any computations as described herein may appear to perform on one component but can be understandably applicably to three components.

One aspect of the present invention is to remove or minimize blocking artifacts in the data 304. In one embodiment, a deblocking process is repeated on every single pixel in the data 304, for example, the process is moving across an entire image or frame. The moving process replaces a pixel with another pixel randomly selected within a region R defined with reference to the pixel being processed. As shown in FIG. 3, a pixel 308 is being processed. When predefined criteria are satisfied, the pixel 308 is replaced by another pixel 310 in the region 312. Depending on implementation, the region may be defined to be of quadrilateral, circle or vary in accordance with the pixel or the surrounding pixels thereof.

According to one embodiment, a region R is adaptively defined. The embodiment may be described by the following operations or process.

Step A, applying a thresholding operation to detect possible edges. One exemplary thresholding operation may be the one used in the conventional approach as described above. One of the differences, however, is to detect all level differences including those minor differences in the ranges of 1 or 2.

Step B, applying a blurring operation to the pixels that have been identified in Step A. The blurring operation involves the following steps.
B1. The blurring operation is done in a two-step process, horizontally first followed by vertically by using a 1-D convolution matrix including weights for surrounding pixels;
B2. The convolution matrix is of a linear rectangular window with equal linear weights to all pixels in a radius. The radius is chosen as a half of the smaller of two values: the length of identical pixels (i.e., pixels differing in a level less than 1, in case the source bit-depth extends beyond the decimal point) on the left side of the edge pixel detected above, and the length on the right side thereof;
B3. The result of this operation returns a floating point number (because of the averaging operation) increasing the bit-depth (below the decimal point) of the picture after the horizontal pass; and
B4. The vertical pass is then followed without truncation of the values produced by the horizontal pass. The results of the vertical pass are returned to the original bit depth using randomized rounding, namely truncating a floating point number after the floating point number is added a random floating point number between 0 and 1.

The above embodiment shows that the blurring process is carried out in floating point domain. In another embodiment, the blurring process is carried out in integer domain. All pixels used in the convolution are expanded to a higher bit precision. For example, pixels used for the convolution in an 8-bit image are first expanded to 10-bit, a result from the convolution is 10-bit and then truncated back to 8-bit.

As described above in one embodiment, the randomized rounding operation is used to bring down a bit depth of an image. It is understood to those skilled in the art that this is not the only process by which a bit depth can be reduced. In fact, depending on implementation, any process that uses fewer colors but more pixels to achieve shades in between those colors is considered dithering, which can also be used to reduce the bit depth. One such an example is Floyd-Steinberg dithering. A common technique to round a pixel value, e.g., 100.5 to 100 or 101, is by a position of the pixel in the image. If the coordinates of a pixel are represented by (x, y), then (x+y) may be used to determine the rounding. For example, if x+y is odd, then 100.5 is rounded to 100. If x+y is even, 100.5 is rounded to 101.

In any case, it may be appreciated by those skilled in the art that the above process may be implemented in software, hardware or a combination of both. The following is a set of pseudocode according to one embodiment. As used in the embodiment, screen[y] is row y of the image to be processed and screen[y][x] is a color level of the pixel at the coordinates (x, y).

function deblock( )
{

for (i) in (1..height) {

deblock1d(screen[i], screen_h[i]) //Horizontal pass
/* The output is stored in screen_h */

}
transpose(screen_h) //Interchange rows and columns
for (i) in (1..width) {

deblock1d(screen_h[i], screen_hv[i]) //Vertical pass

}
transpose(screen_hv)
/* Now screen_hv has the values in the right order */
for (i,j) in (1..height,1..width) {

screen[i][j]=round(screen_hv[i][j]+rand(0,1))
/* Randomized round, rand(0,1) returns random
returns a number between 0 and 1 */

}

}
function deblock1d(sourceline,destline)
{

/* Sourceline is deblocked into destline, the width
is assumed to be in linewidth */
/* Copy source to destination first */
copy(sourceline,destline)
for (i) in (2..linewidth) {

if (abs(sourceline[i]−sourceline[i−1])

> threshold) {
dist_l=same_color_left(sourceline,i)
dist_r=same_color_right(sourceline,i+1)
/* Find how far the color at sourceline[i]
extends left and sourceline[i+1] extends
right */
radius=minimum(dist_l,dist_r)/2;
for (j) in (i−radius..i+radius−1) {

destline[j]=blur(destline, j, radius)

/* Blur(destline,j, radius) may be implemented as equal to the
average of all pixels from destline[j−radius] to
destline[j+radius−1]
Clearly, any number of variations on this idea is possible*/

}

}

}

}

In accordance with one aspect of the present invention, there are several parameters that may be adjusted to accelerate the above process. For example, the radius of the blurring operation passed to the blurring function may be limited to a pre-defined maximum value so that computation and memory costs can be reduced. Alternatively, the radius of blurring in the horizontal or vertical direction may be two different values. In particular, a value of 0 for either directional would result in pure horizontal or pure vertical blurring. This avoids having to do two passes, and enables line-by-line processing when there is a limitation on the number of horizontal lines that can be read/retained in memory at any one time. Further, the two passes can be switched to a single pass and a small kernel of pixels around each edge can be blurred. An example is a square matrix of 5×5 kernel with the pixel to be blurred at the center. According to one embodiment, the boundary or edge detection can be performed at fewer points, like only at 8×8 boundaries of the original image. In another embodiment, the blurring can be changed to randomly replace the pixel with some other pixels inside a region (or a kernel if chosen) and the randomized round step may be eliminated.

According to one embodiment, a smoothness condition may be applied before the operation as discussed above. This smoothness condition avoids replacement of a pixel in areas of high geometric detail by analyzing a small window of pixels around it, for example, in a 3×3 window. If more than a predefined number of pixels in the window differ from the average value (or a median, or a conveniently computable statistical mean function) of the total pixels in the window, the pixel is not considered for the smoothing function.

In the pseudocode below, it is assumed that screen (x, y) is a pixel at location (x, y) in an image or frame. If x or y are out of bounds (i.e., below 0 or above the width or height of an image, they are assumed to be clipped to 0 or the width/height). The parameters MAXTRIES, RADIUS, THRESHOLD and SMOOTHNESS in the code below can be adjusted.

An example of the smoothness function is_it_smooth (i, j) may be implemented as:

is_it_smooth(i,j){

for (ii,jj) in (i−1,j−1)to(i+1,j+1) /* Nine pixels */
{

(dif_sum(ii,jj) <SMOOTHNESS)/*dif_sum is a function*/

return true;

}
return false;

}

It may be noted that the outer for loop may be removed to provide a subtle alternative.

dif_sum(i,j) {

dif_sum=0;
for (ii,jj) in (i−1,j−1)to(i+1,j+1) { /* Nine pixels */

abs=absolute_value(screen[i,j]−screen[ii,jj]);
dif_sum=dif_sum+abs;

}
return dif_sum;

}

It is known that when the bit-rate of an MPEG-2 stream is low, the blocks, specifically the boundaries between them, can be very visible and may clearly detract from the visual quality of the video. A deblocking process is a post-processing step that adaptively smoothes the edges between adjacent blocks. Both FIG. 3A and FIG. 3B show how to eliminate blocking artifacts by post-processing at least a portion of the decoded video by using the techniques described herein.

For the compression standards (e.g., H.264), however, an in-loop deblocking is introduced. The “in-loop” deblocker is actually used as part of the decoding process, and in the decoding ‘loop’. After each frame is decoded, the uncompressed data is passed through the in-loop deblocking process in an attempt to eliminate the artificial edges on block boundaries.

Each compression standard, or decoder may specify its own deblocking algorithm. However, these deblocking algorithms often suffer from the same LSB problem that was discussed above. The deblocking algorithms always round up or down deterministically due to limitations in precision, leading to poor deblocking. According to one embodiment, the randomization in the deblocking process as described above is used to achieve dithered edges via the in-loop deblocker. For example, instead of requiring that all values between 100 and 100.5 will always be rounded down to 100, and all values between 100.5 and 101 will always be rounded up to 101, the deblocking process is configured to require that a value 100.x be randomly rounded up to 101 or down to 100 with probabilities that depend on the exact value of x.

According to another embodiment, an encoder is modified to ensure that the encoded video does not contain blocks in smooth areas in such a way that does not require the use of too many additional bits for encoding. It is understood that source data is naturally “noisy” or “dithered” in areas with smooth gradients due to the nature of the acquisition process. For example, a digital camera that is focused on a smooth gradient of color acquires a dithered image which appears smooth to the naked eye. Each successive frame of the source material has a different noise pattern due to the randomized nature of the content acquisition. This means that, to accurately compress the noise, a separate noise pattern has to be encoded for each frame. In general, noise does not compress well because of its naturally high entropy. Thus, representing noise accurately requires a lot of bits, if they are subsequently recovered with some fidelity.

The noise, however, does not need to be represented accurately since the human eyes are not sensitive to the exact geometry of noise, namely, one noise pattern appears to be similar to another noise pattern to the human eyes, provided the noise was caused statistically. This means that, instead of representing the original sequence of noise patterns in the source frames, it is possible to represent a different sequence of noise patterns in the encoded frames that appear substantially similar. The difference is that the sequence of noise patterns that are chosen to encode will be much more compressible than the original sequence.

In one embodiment, a first frame in a sequence (e.g., a GOP) is encoded with more bits and all I-blocks represent the noise accurately, if any. For succeeding frames, instead of representing the noise accurately for the frames, instead of reusing the noisy blocks from the previous frame, the encoding process is configured to move the blocks around using random motion vectors to provide an illusion of the noise that changes from frame to frame. These random motion vectors can be compressed very well, resulting in the use of very few extra bits.

According to another embodiment, a first frame in a sequence (e.g., a GOP) is again encoded with more bits to accurately represent the noise. The succeeding frames use P-blocks to encode only the difference from blocks represented in the first frame. Moreover, these P-blocks are themselves compressed by dropping the high-frequency components and encoding only the low-frequency components.

One skilled in the art will recognize that elements of the present invention may be implemented in software, but can be implemented in hardware or a combination of hardware and software. The invention can also be embodied as computer-readable code on a computer-readable medium. The computer-readable medium can be any data-storage device that can store data which can be thereafter be read by a computer system. The computer-readable media can also be distributed over network-coupled computer systems so that the computer-readable code is stored and executed in a distributed fashion.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

We claim:

1. A method for minimizing blocking artifacts in an image, the method comprising:
determining a pixel to be processed;
defining a region adaptively with respect to the pixel, the region determined in accordance with a smaller one of two values: a length of identical pixels on a left side and a length on a right side of the pixel determined above; and
if a rounding operation is carried out in real number,
truncating a floating point number after the floating point number is added a random floating point number between 0 and 1, wherein the floating point number is a result of a convolution computation on surrounding pixels and the determined pixel, or
if a rounding operation is carried out in integer number,
truncating an integer number to an original bit precision when the integer number is a result of a convolution computation on surrounding pixels and the determined pixel that all have been expanded to a higher bit precision.

2. The method as recited in claim 1, wherein the determining of the pixel to be processed comprises scanning all pixels sequentially in the image.

3. The method as recited in claim 2, wherein the image is one of a plurality of frames in video data that is recovered from a compressed version thereof.

4. The method as recited in claim 3, wherein the compressed version is created from an original version in accordance with a standard.

5. The method as recited in claim 4, wherein the standard involves one or more compression techniques that operate on blocks that potentially cause the blocking artifacts.

6. The method as recited in claim 1, wherein a radius of the region is a half of the smaller one of two values.

7. The method as recited in claim 1, wherein the truncating of the floating point number comprises:
providing a convolution matrix including weights for surrounding pixels; and
applying the convolution matrix to the surrounding pixels and/or the determined pixel to increase a bit-depth of the determined pixel.

8. The method as recited in claim 1, wherein the method is implemented in an in-line deblocker designated for a compression standard.

9. The method as recited in claim 8, wherein the compression standard is H.264.

10. An apparatus for minimizing blocking artifacts in an image, the apparatus comprising:
memory for storing code as a deblocking module;
a processor, coupled to the memory, executing the deblocking module to cause the apparatus to perform operations of:
determining a pixel to be processed;
defining a region adaptively with respect to the pixel, the region determined in accordance with a smaller one of two values: a length of identical pixels on a left side and a length on a right side of the pixel determined above; and
if a rounding operation is carried out in real number,
truncating a floating point number after the floating point number is added a random floating point number between 0 and 1, wherein the floating point number is a result of a convolution computation on surrounding pixels and the determined pixel, or
if a rounding operation is carried out in integer number,
truncating an integer number to an original bit precision when the integer number is a result of a convolution computation on surrounding pixels and the determined pixel that all have been expanded to a higher bit precision.

11. The apparatus as recited in claim 10, wherein the determining of the pixel to be processed comprises scanning all pixels sequentially in the image.

12. The apparatus as recited in claim 11, wherein the image is one of a plurality of frames in video data that is recovered from a compressed version thereof.

13. The apparatus as recited in claim 12, wherein the compressed version is created from an original version in accordance with a standard.

14. The apparatus as recited in claim 13, wherein the standard involves one or more compression techniques that operate on blocks that potentially cause the blocking artifacts.

15. The apparatus as recited in claim 10, wherein a radius of the region is a half of the smaller one of two values.

16. The apparatus as recited in claim 10, wherein the operations further comprise:
providing a convolution matrix including weights for surrounding pixels; and
applying the convolution matrix to the surrounding pixels and/or the determined pixel to increase a bit-depth of the determined pixel.

17. The apparatus as recited in claim 10, wherein the operations are implemented in an in-line deblocker designated for a compression standard.

18. The apparatus as recited in claim 17, wherein the compression standard is H.264.
